(19) United States
(12) Patent Application Publication
(10) Pub. No.: US 2021/0261826 A1
(43) Pub. Date: Aug. 26, 2021

(54) ADHESIVE TAPE

(71) Applicant: CERTOPLAST TECHNISCHE KLEBEBÄNDER GMBH, Wuppertal (DE)

(72) Inventor: Timo LEERMANN, Wuppertal (DE)

(21) Appl. No.: 17/253,848

(22) PCT Filed: Mar. 26, 2019
(86) PCT No.: PCT/EP2019/057634

§ 371 Date: Dec. 18, 2020

(30) Foreign Application Priority Data
Jul. 11, 2018 (DE) 20 2018 103 986.5

(51) Int. Cl. C09J 7/21; D06H 1/04

(52) U.S. Cl. CPC C09J 7/21; C09J 2203/302; C09J 2400/263; D06H 1/043

(57) ABSTRACT

The invention relates to an adhesive tape, in particular winding tape for bandaging elongated objects, such as cable bundles in automobiles for example. The adhesive tape has a fabric support (1, 2), additionally an adhesive coating (3) which is applied onto one side or both sides of the fabric support (1, 2), and at least one marking thread (4, 5) which is introduced into the fabric support. According to the invention, the marking thread (4, 5) is a warp and/or weft thread (4, 5) which is incorporated into the fabric support (1, 2) during the production process.

The invention relates to an adhesive tape, in particular a tape for wrapping an elongated object such as a cable bundle in an automobile, with a textile substrate, furthermore with an adhesive applied to one or both faces of the textile substrate adhesive coating, and with at least one introduced into the textile substrate marker filament.

Adhesive tape and especially tape for wrapping a cable bundle in an automobile has to meet a wide range of requirements. First of all, there is special media resistance to, for example, oil and gasoline. Another requirement is high temperature resistance. In fact, such wrapping tape should withstand temperatures in the range of −50° to −40° C. up to +150° C. and more can be required. In addition, low noise emissions are aimed for, for example such that rattling noises from a cable harness wrapped in this way or from cable bundles is prevented.

In addition to these previously described requirements, often also high one abrasion resistance is required to prevent the chafing on the vehicle body. The abrasion resistance can be determined according to the prior art, for example according to WO 2005/085379 [U.S. Pat. No. 8,815,389] based on the LV 312 (2009) standard. Actually there are on this point as a rule different abrasion classes.

Depending on the requirements of the automobile manufacturer or the installation and operating conditions of the motor vehicle equipped with the relevant wiring harness, very different adhesive tapes or wrapping tapes are used. These are usually wound manually around the relevant cable bundle by an assembly worker. To distinguish between the individual adhesive tapes, they are packaged accordingly with markings, product labels on the inside of a roll core so the assembly worker can select and use the prescribed adhesive tape to assemble the cable bundle or the cable set accordingly.

The prefabricated cable harness is then usually installed by the automobile manufacturer. This often happens locally more or less far away from the harness manufacturer. This means that mix-ups are possible. Also nowadays more and more detailed incoming and quality controls are required. There is nothing on the completely assembled wiring harness however to indicated the prescribed tape has been installed or not.

It is true that from the generic prior art according to WO 2016/113132 a continuous sewing filament known as a marker is provided in such an adhesive tape. Indeed the marking serves as a positioning aid when wrapping and to this end makes it possible to accurately position a turn on the previously applied turn along the marker thread therein.

The object of invention is to provide such an adhesive tape that also and especially when installed it is possibly to identify its type, whether the correspondingly specified or the requirements adhesive tape is installed or not.

To attain this technical problem, the invention proposes a generic adhesive tape and in particular wrapping tape for wrapping an elongated object such as a cable bundle in an automobiles wherein the marker filament is incorporated as a warp and/or weft filament during manufacture of the textile substrate.

In contrast to the generic prior art according to WO 2016/113132 the invention thus works with an adhesive tape having a textile substrate wherein at least one weft or warp filament is designed as a marker filament. This means that no additional manufacturing step, as in the known teaching with where the marking filament is sewed into the manufactured tape, but instead the marking filament according to the invention directly incorporated during manufacture into the textile as part of its production process.

According to an advantageous embodiment, the marker filament is in terms of its fineness similar to other warp and/or weft filaments. Suitable textile substrates usable for such adhesive tapes have filament counts between 33 dtex and 550 dtex. Thus thee warp and weft filaments of the textile substrate do not necessarily have to have a particular filament count. Instead, a fabric can also be used at this point in which the warp filaments are thicker than the weft filaments, for example with a weft-filament thicknesses between 2000 dtex/cm and 4000 dtex/cm. In contrast the warp-filament thickness is in the range of 8000 dtex/cm up to 16,000 dtex/cm.

In any case, the fineness of the marker filament is similar to the other weft filaments or the fineness of the marking filament corresponds to the fineness of other warp filaments. This will make the weaving process easier without impairing the existence of the marker filament and instead it can be installed as usual.

The procedure is generally that the marker filament is visible on or in an outer surface of the adhesive tape arranged when installed. Such design is particularly recommended in the event that the textile substrate of the adhesive tape according to the invention is not designed as a one-layer fabric, which is usually the case. But the textile substrate can basically also consist of two interconnected layers of individual fabrics. The two layers of the individual fabrics may be coupled to one another by an adhesive or by appropriate filaments.

In any case, with such a textile substrate constructed as a laminate, it is advantageous if the marking filament is visible on or in the outer surface of the adhesive tape when installed. In the case of the laminate, this means that the marking filament is ultimately incorporated into the individual fabric toward the outside when installed, so the previously described and required quality control can be done even when installed.

So that the marker filament is perfectly distinguished from the other warp and weft filaments can be differentiated and fulfills its reference function, the marker filament generally contrasts with the other warp and/or weft filaments color equipped. For example, the marker filament may be colored red, yellow, green, or blue, while the remaining filaments of the fabric are black. Alternatively or in addition, the marker filament can also be provided with surface properties different from those of the other warp and/or weft filament.

Such a different surface quality of the marking filament compared to the other warp or weft filaments can be, for example, by using a textured marker filament. This way the marker filament will have a surface structure comparable to filaments made from natural fibers. If in contrast, the other warp and/or weft filaments have a smooth surface structure because they are plastic filaments made of, for example, polyamide or polyester, the marker filament can, due to its texture or crinkle structure, be easily differentiated on the surface can be differentiated from this and ensure the desired marking. Another possibility of realizing a different surface quality is to twist the marking filament with 50, 100 or even more turns per meter, as detailed in DE 20 2016 100057 [US 2017/0198418] of applicant. Such a twisting process can also be used to surface condition the marker filament compared to the other untwisted filaments warp and/or weft filaments.

Other alternative or complementary ways of differentiating the marking filaments from the other warp and/or weft filaments are conceivable. Typically the textile substrate according to the invention has a plain weave. In contrast the marker filament can be introduced into the fabric with a different weave especially if several such marker filaments are used. That is often technically difficult to implement, but should nevertheless be mentioned. A different interweave compared to the plain weave is a twill weave, satin weave or tricot weave. Most of the time there are involved multiple dissimilar ties of the same type work to make up the change in the weave to be recognized optically and with the naked eye. In any case, one can also use such a variation of the marking filament and can do this in custom fashion according to the invention tape. In this way, single or multiple properties of the adhesive tape are visually mapped, including and especially when installed.

Most of the time, however, the marker filament has a warp and/or filament similar to the other weft filaments but with contrasting colors, because then with the same and matching weave for all filaments of the fabric can be used and changes in the production process do not have to be made. Since the rest of the warp and/or weft filaments are often colored black or orange or overall have continuous color, the marking filament can be of a contrasting color for this.

In order to achieve this in detail, the marker filament is advantageously manufactured with its color. This can be done, for example, during spinning. Here the desired dye is added to an extruder for spinning the marker filament. Alternatively or in addition to this the marker filament can also be colored after it has been manufactured. To this end, the invention may fall back on so-called dip dyeing whereby the filament is immersed in a dye bath or a dye solution such that the color penetrates in this way all through the marker filament.

In this context there is a further possibility that the marker filaments can have several different colors and/or varying surface textures. Since the manufacture of such marking filaments with different colors, for example, is expensive, one will mostly work with marking filaments of the same color throughout. In any case, there is the possibility that the marking filament has a coding. The coding can for example, be specified by the color of the marker filament. If then the marker filament is additionally textured or twisted, it becomes clear that a practically unlimited number of codes for the adhesive tape according to the invention can be realized, even if only a single marker filament is used. As already explained, the coding mirrors one or more properties of the tape.

As properties of the adhesive tape, the marking filament can for example be based on its indicated temperature resistance. Such adhesive tapes are actually used, for example in that at a certain temperature taking into account a treatment time of typically up to 3000 hours no significant discoloration of the textile substrate takes place, as described in detail in the LV 312 standard. In practice, temperature classes T1 to T5 are differentiated from one another.

Qualification for temperature class T3 corresponds to the fact that, up to a temperature of 125° C., no discoloration can be observed within the specified time. The temperature class T4 belongs to a resistance up to 150° C., and temperature class T5 to a temperature resistance of up to 175° C., as detailed in DE 20 2018 101 649 of applicant is described with further references mentioned therein. In any case the above-described temperature classes T1 to T5 can be identified by a total of five different colors of the marker filament. This can also be used in installed condition of the adhesive tape or on can retrospectively determine, based on the cable set wrappings, whether the adhesive tape of the prescribed temperature class has been installed or not.

Another property of the adhesive tape that can be illustrated with the help of the marker filament is its abrasion resistance. In fact, the abrasion resistance can be divided just like the above-described temperature classes into so-called abrasion classes. Here the presentation of tables and formulas can be unsatisfactory in practice and following the explanations for example in DE 20 2012 103 975 [U.S. Pat. No. 10,351,734] one can be dealing with abrasion classes A to G, based on the previously mentioned standard LV 312 “Adhesive tape for cable harnesses in motor vehicles” (January 2005 or last issue as of October 2009) as a joint test guideline used by Audi, BMW, Mercedes and VW. When testing the abrasion resistance, a mandrel is used having a diameter of 5 mm and equipped with the adhesive tape to be examined. The adhesive tape is now rubbed with a scraper of predetermined force with the number of strokes counted until it is scraped through. The number of strokes is the criterion for the abrasion class.

The abrasion classes A to G described above require in this case a total of seven different colors of the marking filament to create the associated correspondingly identified abrasion classes A to G and make then verifiable and visible to everyone. That is, in this case the color of the abrasion class of the correspondingly colored adhesive tape.

Finally, there is another property of the tape in terms of its abilities for soundproofing can be identified with the help of the marking filament. In this case too, depending on the noise-reducing behavior and according to the standard LV 312 different noise reduction classes can be established, namely A, if no noise reduction is achieved with the help of the adhesive tape up to noise reduction class E, which corresponds to a very high level of noise reduction. Details for classification into the corresponding noise reduction classes are in DE 10 2011 005 763 [U.S. Pat. No. 10,099,457].

Because of the total of five different noise reduction classes A to E, one must use five different colors of the marker filament work to identify the noise reduction classes in question. In any case, it becomes clear that the marking filament makes different properties of the adhesive tape generally visible and comprehensible. In principle, only one marking filament can be used. As a general rule however, one will have to employ several marker filaments if, for example different properties of the adhesive tape need to be displayed simultaneously and clearly.

The marker filament generally matches the material of the remaining warp and/or weft filaments. As already explained above, typically the marking filament as well as the other warp and/or weft filaments are of plastic. For example, all filaments are of polyester or polyamide. In principle, of course, combinations are also conceivable and are encompassed by the invention.

If several marker filaments are used, each of the individual marking filaments represents a respective property and clearly indicates it. For example, a marker filament may indicate the temperature class tolerable by the adhesive tape. Another marker filament can then the show the abrasion resistance of the adhesive tape. A third marker filament may indicate its water resistance or its soundproofing properties. In this way, the marker filaments together define a coding that identifies one or multiple properties of the adhesive tape.

Because the marking filament is a warp and/or weft filament, with the help of several marking filaments, one can apply one or more geometric patterns to the textile substrate. A corresponding coding is produced that corresponds to one or more of the described properties of the adhesive tape.

As a result, the adhesive tape is capable, for the first time, of allowing comprehensive control of the correct equipment of the cable set in ready-made state. Because the one or more marker filaments provide a code for the adhesive tape indicating very different properties visible on the outer surface. These properties may be the subject adhesive tape's temperature class, abrasion resistance, soundproofing properties etc. so that a comprehensive and unambiguous characterization of the adhesive tape is made available, namely also and in particular in to a cable harness assemblers. Up to now this was not possible in this form. These are the main advantages.

In the following, the invention is illustrated in the drawing with reference to an embodiment and explained in more detail.

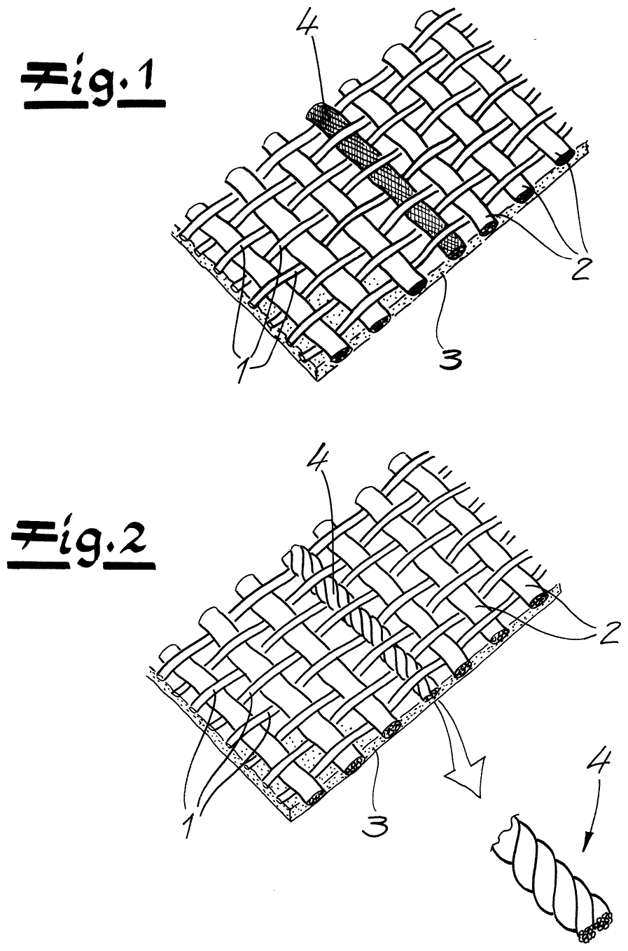

FIG. 1 shows the adhesive tape according to the invention in a first variant with a colored marking filament;

FIG. 2 shows an alternative article according to the invention with a marking filament of different surface texture;

FIG. 3 shows a further variant of the invention with a marker filament of different weave; and

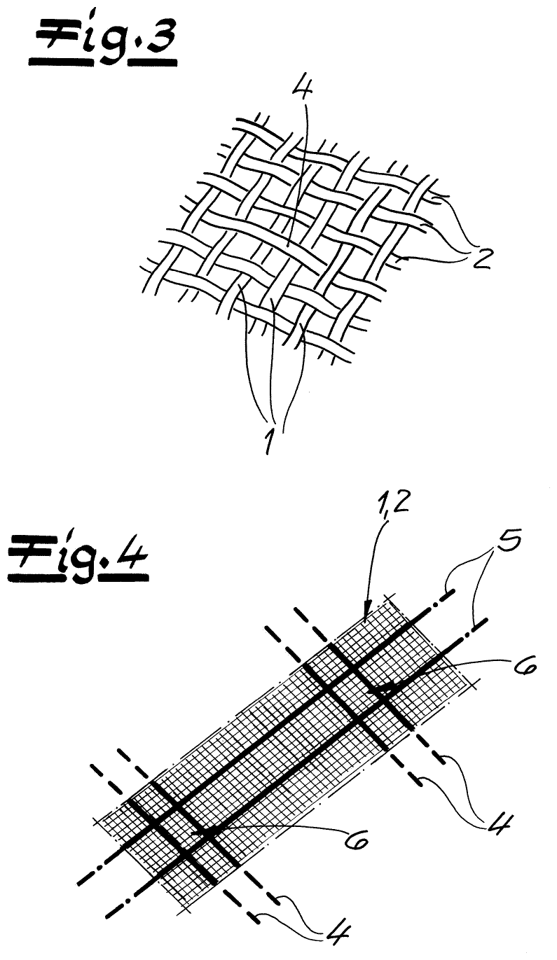

FIG. 4 schematically shows the use of several marking filaments for forming geometric patterns.

In the figures, an adhesive tape is shown that serves for wrapping cable bundles in automobiles. The wrapping tape is used for making cable bundles or sets for automobiles as described and shown in detail in the state of the art representing the starting point according to WO 2016/113132. To this end, the adhesive tape is helically wound around the individual cables.

The adhesive tape or wrapping tape according to the invention is to this end has a textile substrate 1, 2. The textile substrate 1, 2 is made up of warp filaments 1 and weft 2 together. FIG. 1 shows that the weft filaments 2 are significantly thicker than the warp filaments 1, what is of course only to be regarded as an example and is in no way restrictive. According to this embodiment, the textile substrate 1, 2 has an area density in the range of 50 g/m² to 500 g/m². In addition, the textile substrate 1, 2 shown is a monofabric, albeit in principle also a multilayer fabric or laminate formed by the textile substrate 1, 2 and a fleece, a foam or a plastic film is possible.

The textile substrate 1, 2 has an adhesive coating 3 on at least one face. To this end, the adhesive coating 3 may be applied to the textile substrate 1, 2 at a mass per unit area in the range of 50 g/m² to 250 g/m². As glue however, a hot-melt pressure-sensitive adhesive can be applied to the textile substrate 1, 2, without limitation. According to the embodiment, the adhesive coating 3 is only applied to one face to the textile substrate 1, 2. When assembled, the adhesive coating 3 faces inward toward the cables being bundled, whereas the textile substrate 1, 2 faces outward and is thus visible.

Of decisive importance and importance according to the invention is that a marker filament is incorporated as another weft filament 4 in the textile substrate 1, 2, in the embodiment according to FIG. 1 during manufacture of the substrate 1, 2. The one and only marker filament 4 in the embodiment according to FIG. 1 is colored when spun as indicated in FIG. 1. In addition, the marker filament has 4 the same fineness as the other weft filaments 2 of the textile substrate 1, 2. The color of the marker filament 4 contrasts with the color of the other filaments 1, 2.

Depending on the color of the marker filament 4, specific properties of adhesive tape can be identified. For example, the color of the marker filament 4 can indicate the temperature class in which the adhesive tape according to the invention is usable. To this end the marker filament 4 is visible on the outer surface of the adhesive tape when installed. That is to say, as soon as the adhesive tape according to the invention is wrapped helically around the cable bundle or the cable set, the marking filament 4 with its color contrasting with the other filaments 1, 2 can be identified on the assembled cable set. To this end the marker filament may for example be red, white, or brown, to contrast with the other typically black or otherwise colored filaments 1, 2 of the textile substrate 1, 2. Depending on the color the temperature class can be determined, for example brown for temperature class T5, white for temperature class T4 and finally red for temperature class T3.

In FIG. 2, a variant of the marker filament 4 is shown where the marking filament 4 contrasts with the other warp and weft filaments 1, 2 by means of a different surface finish. This different surface finish of the single marker filament 4 as shown in FIG. 2 results from the fact that the marker filament 4 is twisted around its longitudinal axis, as shown in the enlarged illustration is shown in FIG. 2. The twist of the marker filament 4 imparts a different surface quality compared to that of the surface otherwise smoothly laid out remaining filaments 1, 2. It is conceivable that different degrees of twist, that is to say rotations of the marker filament 4 about its longitudinal axis, are associates with respective different temperature classes, which everyone can check and record in this way in the installed condition of the adhesive tape.

In FIG. 3, another variant of the marker filament 4 is shown. Here the marker filament 4 follows a different weave compared to the other filaments 1, 2. In fact, the remaining warp and weft filaments 1, 2 of the textile substrate 1, 2 are in a plain or basket weave. In contrast, the weft filament 4 follows a twill weave. Normally in this case several weft filaments 4 in are set in a twill weave in order to make the different weaves easy to see optically. That means the relevant weft filament or the several relevant weft filaments 4 go under one warp filament 1 and then over at least two corresponding warp filaments or over three warp filaments 1. In contrast, the plain weave of the remaining filaments 1, 2 in that each weft filament 2 goes under a warp filament 1 and then over the next warp filament 1.

In this way, the marking filament 4 again has a different optical appearance easily recognized both from the tape and from the tape is installed in a wiring harness. The number of the warp filaments 1 bridged by the weft filament 2 thus serves a standard for determining the property indicated by the marker filament 4. For example, two can be bridged warp filaments 1 within the framework of the twill weave of the marker filament 4 for temperature class T3 and three bridged warp filaments 2 indicate to temperature class T4. Four bridged warp filaments 2 correspond to temperature class T5.

In FIG. 4, finally, a variant is shown in which with several marker filaments 4, 5 are employed. In fact at this point there are a total of four weft filaments 4 introduced into the fabric 1, 2 as well as two marking warp filaments 5. In this way, the marker filaments 4, 5 taken together form a coding of the properties of the adhesive tape. For example, the marking filaments 4, 5 form as shown in FIG. 4, a geometric pattern in the form of two enclosed squares or rectangles 6. The number of these rectangles or squares 6 can be varied as weft filaments, depending on the marking filaments 4 used, so that on these form a coding of the properties of the adhesive tape according to the invention.

For example, one rectangle or square 6 may belong to temperature class T1. Two rectangles 6 reflect the temperature class T2, etc. in addition, this system combined with different colors on marking filaments 4, 5 can increase the number of possible codings even further.

Overall, it becomes clear that especially using several marking filaments 4, 5 or several geometric patterns, in this case rectangles or squares 6, various codings can be formed. As a result, there is overall and finally the possibility of identifying and checking easily the properties of the adhesive tape according to the invention with the aid of one marking filament 4 or several marking filaments 4, 5. All of this also works in conjunction with a ready-made wiring harness and appropriately installed adhesive tape. These are significant advantages.

1. An adhesive tape for wrapping an elongated object, the tape comprising
a textile substrate,
an adhesive coating applied to one or both faces of the textile substrate, and
a marker filament introduced into the textile substrate, the marker filament being incorporated during manufacture into the textile substrate as a warp and/or weft filament.

2. The adhesive tape according to claim 1, wherein the marking filament is of substantially the same fineness as the other warp and/or weft filaments.

3. The adhesive tape according to claim 1, wherein the marking filament is visible in or on an outer surface of the adhesive tape when installed.

4. The adhesive tape according to claim 1, wherein the marking filament has a color and/or surface property that contrasts or is different from that of the other warp and/or weft filaments.

5. The adhesive tape according to claim 1, wherein the marker filament is colored during its manufacture.

6. The adhesive tape according to claim 1, wherein the marking filament is colored after its manufacture.

7. The adhesive tape according to characterized wherein the marker filaments are of several different colors and/or different surface textures.

8. The adhesive tape according to claim 1, wherein the marker filament has a coding corresponding to one or more properties of the adhesive tape.

9. The adhesive tape according to claim 8, wherein the adhesive tape has properties that are identified by the coding of the marker filament.

10. The adhesive tape according to claim 1, wherein the marker filament is of generally the same material as the other warp and/or weft filaments.

11. The adhesive tape according to one of claims 1 to 10, claim 1, wherein there are several marking filaments in the tape.

12. The adhesive tape according to claim 11, wherein the marking filaments together define a coding of the properties of the adhesive tape.

13. The adhesive tape according to claim 11, wherein the marking filaments collectively form a geometric pattern as coding.

14. A method comprising:
knitting or weaving a plurality of substrate bands from warp and weft filaments having respective and different predetermined properties, with one of the filaments of each band being a marker filament having a color, surface texture, or weave pattern contrasting with the color, surface texture, or weave pattern of the other filaments and particular to the property of the respective band, the marking filaments being visible on one face of the band;
applying an adhesive to an opposite face of each of the bands to form an adhesive tape with a marker tape indicating the respective property visible on the one face;
supplying the tape to a user; and
the user optically evaluating and selecting the band by the property indicated by the respective marker filament and thereafter wrapping the selected band around an elongated object with the face bearing the adhesive against the object and the face on which the marking filament is visible directed outward away from the object, whereby the marker filament of the tape wrapped around the object indicates the property of the tape wrapping the object.
